(19) United States
(12) Patent Application Publication
(10) Pub. No.: US 2022/0073273 A1
(43) Pub. Date: Mar. 10, 2022

(54) MODULAR WASTE RECEPTACLE

(71) Applicant: BANQLOOP, INC., Wilmington, DE (US)

(72) Inventors: James J. BOSKOVIC, Mill Valley, CA (US); Alexandre P. DESLAURIERS, Garibaldi Highlands (CA)

(73) Assignee: BANQLOOP, INC., Wilmington, DE (US)

(21) Appl. No.: 17/468,159

(22) Filed: Sep. 7, 2021

Related U.S. Application Data
(60) Provisional application No. 63/074,909, filed on Sep. 4, 2020.

(51) Int. Cl. B65F 1/00; B65F 1/10; B65F 1/14

(52) U.S. Cl. CPC B65F 1/006; B65F 1/0006; B65F 1/10; B65F 1/14; B65F 2210/176; B65F 2001/1489; B65F 2210/169; B65F 2210/152; B65F 2001/008

(57) ABSTRACT

The disclosure describes waste receptacles for processing waste comprising a waste portal configured to accept waste deposited by an end user, a waste analysis unit positioned proximate to the waste portal, a waste conveyor connected to the waste portal, a paddle or robotic member positioned over the waste conveyor and configured to push the waste off the waste conveyor and into a grinder or into a waste commodity container.

### CROSS-REFERENCE TO RELATED APPLICATIONS

This application claims the benefit of U.S. Provisional Patent No. 63/074,909 filed Sep. 4, 2020, the entirety of which is incorporated by reference herein.

### FIELD

The present disclosure relates generally to waste receptacles, and in particular modular waste receptacles with various useful features such as the ability to grind and separate waste.

### BACKGROUND

Waste receptacles are common fixtures in spaces where people live, work, transit, or gather. Waste receptacles can be simple or complex in design and included features. In the simplest designs, waste receptacles include a hollow or void into which waste is deposited by people, who are referred to herein as end users. Some waste receptacles include multiple hollows or voids into which different materials can be deposited, such as a plastic, metals, glass, and landfill. Others include features intended to prevent animal or pest infestation, secure contents from external access, or permit easy access for removal of accumulated waste. Complex waste receptacles include features such compaction to store more accumulated waste before the waste receptacles need to be emptied.

These conventional waste receptacles have drawbacks. For example, comingling different materials such as food scraps, plastic, glass, liquids, and metals inevitably contaminates each of these materials, thereby increasing the difficulty of recycling by lowering recyclate quality. Even with advances like compactors, a waste receptacle in a high traffic area will be filled quickly, requiring frequent visits by janitorial staff to empty it. If the waste receptacle is not filled, regular visits by janitorial staff are nonetheless required to ensure that it remains ready to accept fresh waste. Additionally, it is sometimes difficult to predict where a waste receptacle will be needed within large facilities or during special events, necessitating the loading, transport, and unloading of a waste receptacle to a temporary locations where they are needed. Similar to the above, this requires frequent attention by janitorial staff. There is a need for a waste receptacle that addresses these and other shortcomings found in conventional waste receptacles.

### SUMMARY

The disclosure describes waste receptacles for processing waste comprising a waste portal configured to accept waste deposited by an end user, a waste analysis unit positioned proximate to the waste portal, a waste conveyor connected to the waste portal, a paddle positioned over the waste conveyor and configured to push the waste off the waste conveyor and into a grinder or into a waste commodity container.

In one embodiment, there is a waste receptacle for processing waste comprising: a waste portal configured to accept waste deposited by an end user, a waste analysis unit positioned proximate to the waste portal, a waste conveyor connected to the waste portal, at least one of a robotic member or a paddle positioned over the waste conveyor and configured to push the waste off the waste conveyor and into a grinder or into a waste commodity container.

In another embodiment, the robotic member or paddle is configured to push the waste off the waste conveyor and into a grinder to thereby produce pulverized waste, the pulverized waste is dried on a porous trap door to form recyclate.

In another embodiment, the recyclate is deposited into a waste commodity container by opening the porous trap door.

In another embodiment, the waste analysis unit includes one or more of a visible light camera, a near infrared camera, a far infrared camera, a UV camera, a camera that detects both visible light and near infrared light, a laser, a light emitting diode (LED), a fluorescent, incandescent, induction, halogen, or LED light, a scale that determines weight, a scale that determines physical dimensions, an optical spectrometer, an X-ray source, an X-ray detector, a metal detector, a barcode reader, or a radio frequency identification (RFID) reader.

In another embodiment, the waste commodity container is a flexible polymer pouch.

In another embodiment, the flexible polymer pouch is biodegradable.

In another embodiment, there is also a laser configured to detect when waste is in the path of the robotic member or the paddle.

In another embodiment, only at least one robotic member is positioned over the waste conveyor.

In another embodiment, only at least one paddle is paddle is positioned over the waste conveyor.

In one embodiment, there is a method of processing waste in a waste receptacle comprising: performing a waste analysis test when waste is deposited by an end user into a waste portal of the waste receptacle, said waste analysis unit being positioned proximate to the waste portal; classifying the waste according to the results of the waste analysis test, permitting the waste to move on a waste conveyor, pushing the waste off the waste conveyor and into a grinder or into a waste commodity container.

In another embodiment, the waste is pushed off the waste conveyor and into a grinder to thereby produce pulverized waste and the pulverized waste is dried on a porous trap door to form recyclate.

In another embodiment, the recyclate is deposited into a waste commodity container by opening the porous trap door.

In another embodiment, the waste analysis test includes one or more of a generating a visible light image, generating a near infrared image, generating a far infrared image, generating a UV, a generating a hyperspectral image that includes both visible light and near infrared light, determining weight, determining physical dimensions, generating an optical spectrograph, generating an X-ray image, detecting metal, reading a bar code, or reading a radio frequency identification (RFID) tag.

In another embodiment, the waste commodity container is a flexible polymer pouch.

In another embodiment, the flexible polymer pouch is biodegradable.

In another embodiment, there is also detecting when the waste passes in the path of at least one of a robotic member and a paddle by illuminating the waste with a laser.

### DRAWINGS

Aspects, features, benefits and advantages of the embodiments described herein will be apparent with regard to the following description, appended claims, and accompanying drawings where:

FIG. 1 depicts a view of a waste receptacle in accordance with an embodiment.

FIG. 2A depicts a view of a waste receptacle in accordance with an embodiment.

FIG. 2B depicts an internal cutaway view along line A-A of FIG. 2A.

FIG. 3A depicts a view of a waste receptacle

FIG. 3B depicts an internal cutaway view along line A-A of FIG. 3A, with the actuator 25 in a first position.

FIG. 3C depicts an internal cutaway view along line A-A of FIG. 3A, with the actuator 25 in a first second extended position.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, “waste” includes one or more of solids, liquids, or gases that are relinquished by a person. Examples of waste include food, beverages, water, containers (whether empty or filled), metal objects, plastic objects, wood objects, glass objects, paper objects, chemicals, electronic circuits (sometimes referred to as “e-waste”), explosives, hazardous materials, and the like. It should be noted that waste includes materials that are voluntarily relinquished by a person, such as food container after finishing a meal, and materials that are not voluntarily relinquished by a person, such as a mobile phone or a passport.

As used herein, the term “end user” includes any person or thing (such as a robot or other machine) that deposits waste into a waste receptacle.

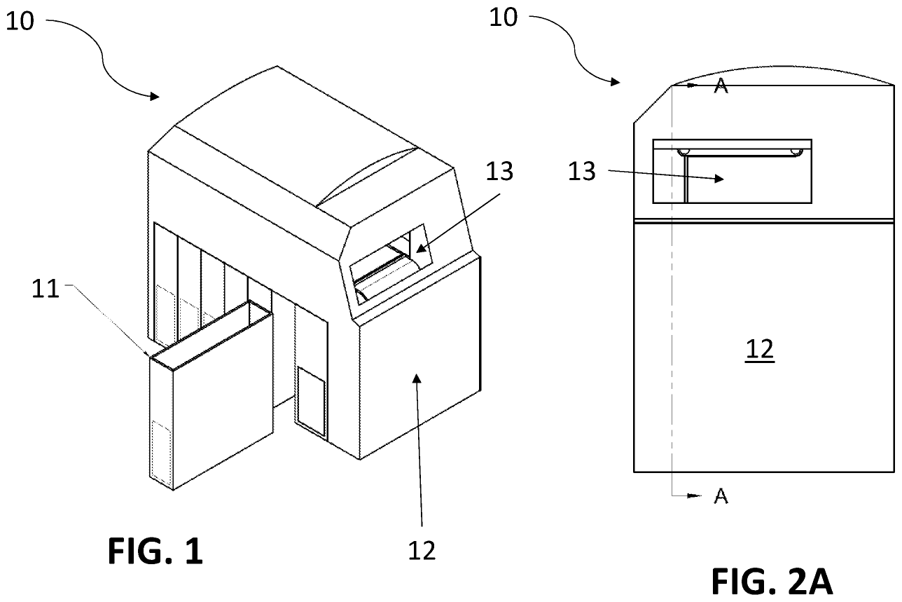

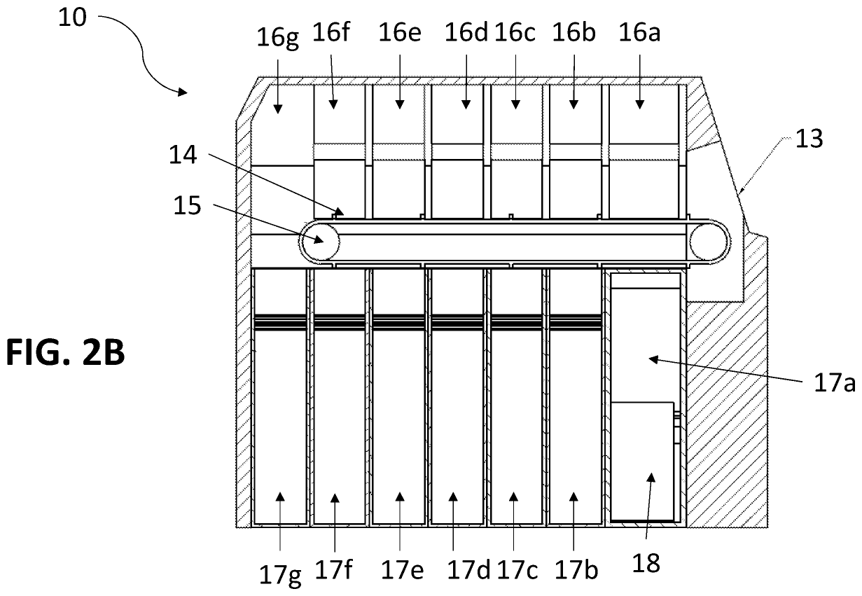

Referring to FIG. 1, waste receptacle 10 is a modular design that includes one or more bin modules 11. Each bin module 11 can be removed completely for the emptying of waste or alternatively for maintenance. Waste receptacle 10 includes a front surface 12 and an waste portal 13 into which waste is deposited by one or more end users (not shown). The front surface 12 may optionally include at least one of a liquid sink or a compost portal (not shown). When compost is to be accepted, additional signage may be provided to inform users that they can dispose these in the separate liquid sink or compost portal. FIG. 2A shows the waste receptacle 10 in a view looking directly at the front surface 12. Similar to FIG. 1, the waste receptacle 10 includes a waste portal 13 positioned above the front surface 12.

FIG. 2B shows an internal cutaway of the cross-section of line A-A in FIG. 2A. In FIG. 2B, waste is deposited by an end user into the waste receptacle 10 by way of the waste portal 13. After being deposited into the waste portal 13, the waste is transported by a waste conveyor in the form of a conveyor belt 14 that is driven by one or more rollers 15. It should be noted that the waste conveyor is not limited and includes roller belts, conveyor belts, or mesh belts. The rollers 15 are driven by a gearing drive, however the disclosure also contemplates other ways of driving the rollers and thereby the conveyor belt are possible such as individual servo motors.

As the waste moves along the conveyor belt 14, it passes through one or more paddle zones 16a-16f in FIG. 2B. While six paddle zones are shown in FIG. 2A, skilled practitioners will appreciate that more paddle zones or fewer paddle zones can be deployed depending on many factors, such as the kinds of waste encountered in a particular location and the amount of waste encountered in a particular location. In addition to paddle zones 16a-16f, there is also a final, paddle-free zone 16g where waste is transported by the conveyor belt and arrives if the paddles present in paddle zones 16-16f are not actuated to remove the waste from the conveyor belt. The paddle free zone does not contain a paddle or other similar actuator that can remove or otherwise redirect incoming waste. As such, all waste that reaches the paddle free zone must enter the final bin for questionable items. The paddle zones include at least a laser to detect waste and thereby control whether the paddle should actuate. Each paddle zone and the paddle free zone corresponds to a different kind of waste that is intended to be separated from the other waste and processed to form recyclate.

Also shown in FIG. 2B, below the paddle zones 16-16f and the paddle-free zone 16g are positioned above one or more individual grinders (not shown). Each grinder accepts the waste that is pushed off of the conveyor belt 14 and grinds the waste into small particles. These small particles of specified material are referred to as recyclate, and they can be inputted into material recycling or recovery processes.

Examples of recyclate include one or more of ferrous metals (including iron, steel, and similar alloys), non-ferrous materials (including aluminum), cellulosic materials (including paper, paperboard, cardboard, and corrugated cardboard), glass (including clear glass and colored glass, said colored glass itself including one or more of green glass, amber glass, and brown glass), organic waste, plastic waste (including recycled plastic materials having resin identification codes such as polyethylene terephthalate (PET), high density polyethylene (HDPE), polyvinyl chloride (PVC), low density polyethylene (LDPE), polypropylene (PP), and other plastics such acrylic, polyester (nylon), polycarbonate, and polylactic acid).

After the waste has been pulverized by the grinders it is referred to as pulverized waste, it falls by gravity onto a porous trap door (not shown). On the porous trap door, any liquids that are collected during grinding are collected through a porous trap door and routed to a gutter. The gutter can direct the liquid to a tank that is periodically emptied, or if available, a sewer pipe for the liquid. Once the pulverized waste is dry or otherwise useable for a subsequent recycling operation, it is referred to as recyclate. When the pulverized waste is sufficiently dry, a trap door opens and falls into a previously positioned waste commodity container (not shown). The waste commodity container thus contains sorted, cleaned, and pulverized recyclate that can be recycled to form new products. The waste commodity containers are positioned within one or more of the modular bins 17-17g of FIG. 2. Each modular bin contains at least one coded receptacle for holding tracking and holding waste. For example, the coded receptacle can be formed of a flexible polymeric pouch material. In some embodiments, the flexible polymeric pouch material is a biodegradable polymer or blend of biodegradable polymers. Examples of biodegradable polymers are not limited and include polylactic acid.

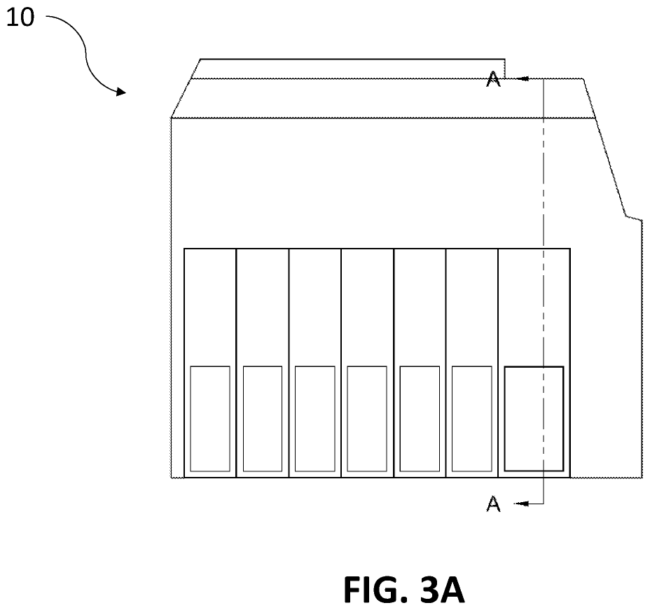

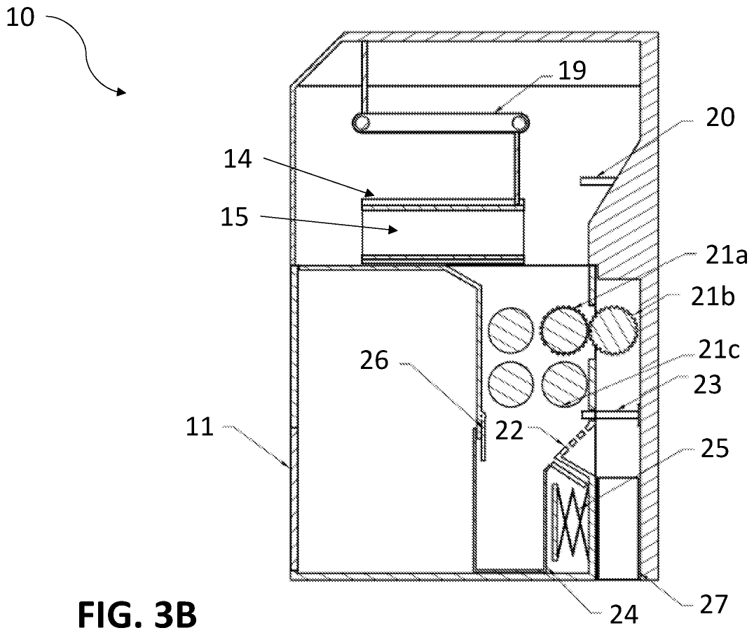

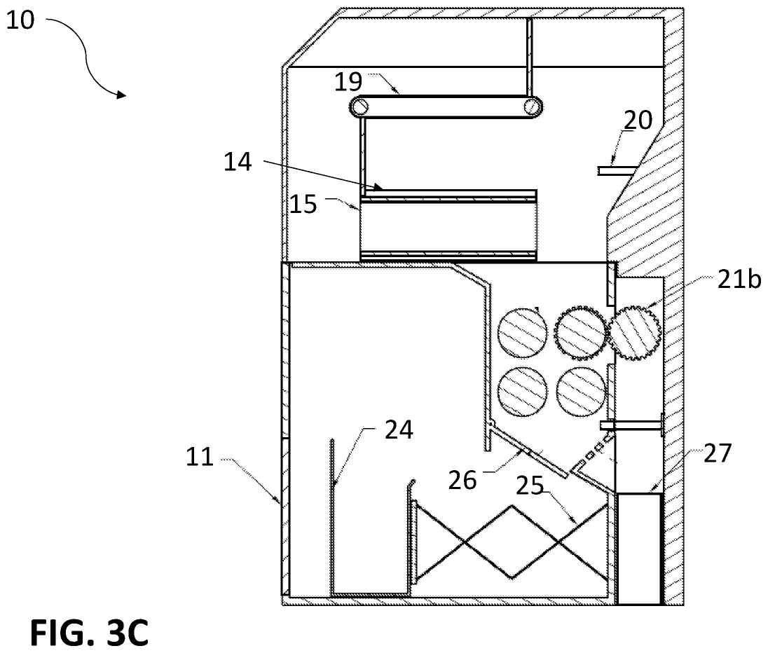

Referring to FIG. 3A, a view is depicted of an internal cross section of the waste receptacle 10, which is intersected by line A-A. FIG. 3B is a view taken along the cross-section formed by line A-A. In FIG. 3B, waste moves down conveyor 14 which is powered by rollers 15. Paddle 19 pushes the waste off of the conveyor 14 when commanded by a processor when the waste is detected by laser 20. After being pushed off of the conveyor 14, the waste falls down by gravity and enters the grinder, which include grinder rollers 21a, 22b, and 22c. It should be noted that while FIG. 3B shows three grinder rollers, the design is not so limited and additional or fewer rollers may be included as needed.

After the waste passes through the grinders, it is referred to as pulverized waste and moves to the porous trap door 22. Once the pulverized waste has been sufficiently drained of water by the porous trap door 22, the porous trap door opens and permits the pulverized waste, which is now referred to as recyclate, to fall into a pre-positioned waste commodity container 24. When the porous trap door requires cleaning, a cleaning spray of compressed air and anti-bacterial solution can be sprayed by nozzle 23 onto the porous trap door. In FIG. 3B, the recyclate continues to fill waste commodity container 24, which in certain embodiments takes the form of a flexible, biodegradable polymer pouch that has an identifying bar code which identifies the kind of recyclate contained therein. In FIG. 3B, the waste commodity container door seals the waste commodity container 24 from the modular bin 11.

FIG. 3C is the same as FIG. 3B above, but in FIG. 3C the actuator 25 has been activated to push waste commodity container 26, which is full of recyclate, into the modular bin 11. While the actuator 25 pushes waste commodity container 24 to modular bin 11, additional waste commodity containers 27 are ready to be inserted to the actuator 25 in order to offer additional capacity for collecting recyclate.

When the waste commodity container 24 is detected to be full, an actuator 25 is activated which pushes the waste commodity container through the waste commodity container door 26 and into the bin module 11. During the entire process, the identity of the waste commodity container and its contents is tracked because the waste commodity container includes at least one machine readable identifier, which can include one or more of a bar code or a radio frequency identification (RFID) tag.

In the above description and referenced drawings, one or more paddles are detailed which push the waste off at least one conveyor. However, the disclosure is not so limited and other ways of removing the waste from at least one conveyor and causing the waste to be deposited into the grinder or in other locations are also contemplated. For example, in certain embodiments, instead of a paddle, a robotic member such as a robotic arm is provided. When the robotic member is provided as a replacement for or as a substitute to one or more paddles, the robotic member is configured to perform one or more of grasping, moving, or sorting the waste. In certain configurations, the robotic members permit faster, higher volume or higher item count handling than paddles.

One or more waste analysis units are positioned outside, inside, or along the waste identification portal. In other embodiments, waste analysis units can be placed in other locations of the waste receptacle, such as within a bin module that is configured to receive waste of unknown composition. Each of the one or more waste analysis units performs one or more waste analysis tests. The waste analysis units and their associated tests assist the waste receptacle in determining the identity of each piece of waste that is deposited therein. By determining the identity of the waste that is deposited within the waste receptacle, the waste receptacle can determine which subsequent processing steps should be undertaken for the waste.

The waste analysis unit includes one or more of a visible light camera, a near infrared camera, a far infrared camera, a UV camera, a camera that detects both visible light and near infrared light, a laser, a light emitting diode (LED), a fluorescent, incandescent, induction, halogen, or LED light, a scale that determines weight, a scale that determines physical dimensions, an optical spectrometer, an X-ray source, an X-ray detector, or a metal detector. The LED, lasers, fluorescent, incandescent, induction, halogen, or LED light listed above can be configured to emit, by material selection, optical filtering, or both, at least one of ultraviolet (UV) light, visible light, near infrared light, or far infrared light. In some embodiments, the waste analysis unit includes a device that is capable of reading and outputting machine readable code that is present on the waste. For example, the waste analysis unit can include a barcode reader or a radio frequency identification (RFID) reader.

The one or more waste analysis units described above performs one or more waste analysis tests. Such waste analysis tests are not limited and include generating a UV image of the waste, generating a visible image of the waste, generating a near infrared image of the waste, generating a far infrared image of the waste, generating a hyperspectral image of the waste, generating an X-ray image of the waste, determining a weight of the waste, determining a physical dimension of the waste, or determining a metal content of the waste.

When the waste analysis unit produces or detects electromagnetic radiation including X-rays, UV light, visible light, near infrared light, or far infrared light, the waste analysis unit can simultaneously perform one or more of the other listed waste analysis tests, such as determining a weight of the waste, determining a physical dimension of the waste, or determining the metal content of the waste.

The rate that the waste analysis unit gathers data, such as image, in a waste analysis test is not limited. However, the rate of performing waste analysis tests must be fast enough so that end users can conveniently deposit waste into the waste receptacle with minimal time expended. In some embodiments, the rate that each complete iteration of the waste analysis test is performed is less than about 4 seconds, less than about 3.0 seconds, less than about 2.0 seconds, less than about 1.0 second, less than about 0.75 seconds, less than about 0.5 seconds, less than about 0.25 seconds, less than about 0.10 seconds, or less than about 0.05 seconds. For each of those ranges, in some of the embodiment the lower value of the range is 0.01 seconds or 0.02 seconds. In some embodiments, the rate that iterations of the waste analysis test is performed is measured in Hz, and the rate is about 100 Hz to about 1 Hz, about 90 Hz to about 1 Hz, about 80 Hz to about 1 Hz, about 70 Hz to about 1 Hz, about 60 Hz to about 1 Hz, about 50 Hz to about 1 Hz, about 40 Hz to about 1 Hz, about 30 Hz to about 1 Hz, about 20 Hz to about 1 Hz, or about 10 Hz to about 1 Hz.

In some embodiments, the waste receptacle include one or more high intensity UV lamps that are intended to clean and disinfect one or more of the waste and one or more of the surfaces that are internal to the waste receptacle. In other embodiments, there are one or more sources of compressed air that are used to clean surfaces that can become dirty or fouled as a result of contact and processing of waste. In particular, such UV lamps can be configured or directed so that ultraviolet radiation reaches the conveyor belt and the rollers which come in frequent contact with waste. Alternatively or in addition to UV lamps, compressed air can physically remove waste that has accumulated on surfaces that become dirty or fouled as a result of contact and processing of waste. Still further, it is also contemplated that a cleaning spray (such as an antibacterial cleaning spray) can be injected into compressed air that is used to clean and disinfect the various surfaces internal to the waste receptacle.

The waste receptacle 10 may include a variety of external features which can be customized depending the location and functionality of the waste receptacle 10. In certain embodiments, an external waste chute (not shown) is affixed to the waste portal 13 to allow end users to deposit waste into the waste receptacle 10. Such an external waste chute is angled to allow waste to roll or slide into the waste portal 13. The waste chute might also continue into the waste portal 13, forming an internal waste chute that is separate or unified with the external waste chute. To assist end users in using the waste receptacle 10, janitorial staff in emptying the waste receptacle, or maintenance staff in servicing the waste receptacle, an instructional display is attached in some embodiments to the waste receptacle or is alternatively provided nearby to the waste receptacle. In some embodiments, the waste receptacle includes one or more indicator lights on at least one surface of the waste receptacle, such as on the front surface 12. The indicator lights indicate how many waste commodity containers have been filled, thus providing quick reference to janitorial staff regarding the status of the waste receptacle and whether the receptacle needs to be emptied or have its waste commodity containers (such as pouches) refilled.

In certain embodiments, the waste receptacle includes a compost module, or a liquids module or a compost module and a liquids module. The compost module and the liquids module are each separate and do not include any grinder or waste conveyors therein. Instead, the compost module allows end users to affirmatively separate food waste from other waste that is being deposited into the waste portal. The liquids module, which may take the of a sink or funnel, allows end users to affirmatively pour out liquids such as beverages from containers before depositing the empty containers into the waste portal. The compost module or liquids module or both the compost module and the liquids module are located in close proximity to the waste portal.

The waste receptacle operates by electricity, and the electricity source is selected depending on the location, anticipated traffic of end users, the availability of the electricity. In outdoor locations where electrical infrastructure is not available, the waste receptacle may be equipped with one or more solar panels and one or more batteries to store accumulated energy. In locations, whether indoor or outdoor, where electrical infrastructure is available, the waste receptacle may be plugged into an electrical receptacle. It should be noted that in certain locations, such as airports, train stations, bus stations, or other similar transportation hub, the people often compete for comparatively few end users to use electrical power for their laptops, mobile phones, and other personal electronic devices. Thus, in such locations it is desirable to “hard-wire” or connect the waste receptacle to electrical infrastructure without a conventional electrical receptacle that can be unplugged. While these examples are provided for the electricity source and the way that it is connected to the electricity source, it is appreciated by those skilled in the art that other sources of electricity can be used.

In another aspect of the disclosure, the waste receptacle includes one or more of a processor, a random access memory (RAM), a hard drive or solid state drive, an external network interface, a human interface device, and an internal network for transferring data. These elements are variously connected to, for example, the waste analysis unit in order to transfer and process the data from one or more waste analysis tests. These elements can also be connected to the paddles, the actuator, the grinder, the laser, the porous trap door, the waste commodity container door, and sensors that are implemented in the waste receptacle. In this way, the processor obtains and processes the information from the waste analysis unit to determine one or more of the identity of a waste item, the likely material composition of the waste item, and by that determination operates the various parts of the waste receptacle in order to separate, grind, or separate and grind the waste.

In certain examples of the embodiments described above where the processor obtains and processes the information from the waste analysis unit to determine one or more of the identity of a waste item, the likely material composition of the waste item, and by that determination operates the various parts of the waste receptacle in order to separate, grind, or separate and grind the waste, the determination is performed by an artificial the processor performing an artificial intelligence algorithm. For example, the waste analysis unit can send visible light images to the processor, and the processor performs object recognition and identifies the waste composition, as well as identifying the potential vendor of waste.

In some advantageous embodiments, the processor can, upon set conditions, send a message over a network to janitorial staff comprising one or more of a message that a bin module is substantially filled, that a bin module is filled and cannot accept more recyclable materials, that the maintenance is required, that an unknown object has been deposited, that a suspected weapon or explosive has been deposited (this is particularly important for transportation hubs such as airports), that replenishment of waste commodity containers is required. In other conditions, the message can be sent to end users to inform them of one or more of the location of the waste receptacle, the maintenance status of the receptacle, or instructions to operate the waste receptacle.

The waste receptacle is not limited in its use or deployment. In some embodiments, the waste receptacle is provided as a stationary installation and does not substantially move during normal operation. In other embodiments, the waste receptacle is mounted to a vehicle so that it can be moved while it is being used. Examples of mounting the waste receptacle to vehicles include mounting to one or more of cars, trucks, buses, trains, airplanes, ships, carts (both hand carts and motorized carts), and any other vehicle that is commonly used to transport passengers or freight. By mounting the waste receptacle to a vehicle, the waste receptacle can be moved wherever it is require, such as to fulfill short-term needs or as part of a regular schedule of movements. In still other advantageous embodiments, the waste receptacle substantially fills the internal dimensions of the vehicle so as to maximize the amount of recyclate that can be collected from a single waste receptacle according to the disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 containers refers to groups having 1, 2, or 3 containers. Similarly, a group having 1-5 containers refers to groups having 1, 2, 3, 4, or 5 containers, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A waste receptacle for processing waste comprising:
a waste portal configured to accept waste deposited by an end user,
a waste analysis unit positioned proximate to the waste portal,
a waste conveyor connected to the waste portal,
at least one of a robotic member or a paddle positioned over the waste conveyor and configured to push the waste off the waste conveyor and into a grinder or into a waste commodity container.

2. The waste receptacle of claim 1, wherein:
the robotic member or paddle is configured to push the waste off the waste conveyor and into a grinder to thereby produce pulverized waste,
the pulverized waste is dried on a porous trap door to form recyclate.

3. The waste receptacle of claim 2, wherein the recyclate is deposited into a waste commodity container by opening the porous trap door.

4. The waste receptacle of claim 1, wherein the waste analysis unit includes one or more of a visible light camera, a near infrared camera, a far infrared camera, a UV camera, a camera that detects both visible light and near infrared light, a laser, a light emitting diode (LED), a fluorescent, incandescent, induction, halogen, or LED light, a scale that determines weight, a scale that determines physical dimensions, an optical spectrometer, an X-ray source, an X-ray detector, a metal detector, a barcode reader, or a radio frequency identification (RFID) reader.

5. The waste receptacle of claim 1, wherein the waste commodity container is a flexible polymer pouch.

6. The waste receptacle of claim 4, wherein the flexible polymer pouch is biodegradable.

7. The waste receptacle of claim 1, further comprising a laser configured to detect when waste is in the path of the robotic member or the paddle.

8. The waste receptacle of claim 1, wherein only at least one robotic member is positioned over the waste conveyor.

9. The waste receptacle of claim 1, wherein only at least one paddle is paddle is positioned over the waste conveyor.

10. A method of processing waste in a waste receptacle comprising:
performing a waste analysis test when waste is deposited by an end user into a waste portal of the waste receptacle, said waste analysis unit being positioned proximate to the waste portal;
classifying the waste according to the results of the waste analysis test,
permitting the waste to move on a waste conveyor,
pushing the waste off the waste conveyor and into a grinder or into a waste commodity container.

11. The method of claim 10, wherein the waste is pushed off the waste conveyor and into a grinder to thereby produce pulverized waste and the pulverized waste is dried on a porous trap door to form recyclate.

12. The method of claim 11, wherein the recyclate is deposited into a waste commodity container by opening the porous trap door.

13. The method of claim 10, wherein the waste analysis test includes one or more of a generating a visible light image, generating a near infrared image, generating a far infrared image, generating a UV, a generating a hyperspectral image that includes both visible light and near infrared light, determining weight, determining physical dimensions, generating an optical spectrograph, generating an X-ray image, detecting metal, reading a bar code, or reading a radio frequency identification (RFID) tag.

14. The method of claim 10, wherein the waste commodity container is a flexible polymer pouch.

15. The method of claim 14, wherein the flexible polymer pouch is biodegradable.

16. The method of claim 10, further comprising detecting when the waste passes in the path of at least one of a robotic member and a paddle by illuminating the waste with a laser.
